(19) United States
(12) Patent Application Publication
(10) Pub. No.: US 2025/0380661 A1
(43) Pub. Date: Dec. 18, 2025

(54) DEODORIZING POUCH FOR PET URINE ODOR PREVENTION

(71) Applicant: Linda Shidler, Medina, OH (US)

(72) Inventor: Linda Shidler, Medina, OH (US)

(21) Appl. No.: 19/284,898

(22) Filed: Jul. 30, 2025

Related U.S. Application Data
(63) Continuation-in-part of application No. 18/741,967, filed on Jun. 13, 2024.

(51) Int. Cl. A01K 1/01

(52) U.S. Cl. CPC A01K 1/01

(57) ABSTRACT

The present disclosure provides a deodorizing pouch, comprising: at least one layer, being made of breathable material; and a powder contained within the inner layer, said powder having aromatic deodorizing properties. A preferred embodiment includes an outer layer and an inner layer. The outer layer may be made of a breathable cotton blend fabric, while the inner layer may be made of fusible interfacing. The powder comprises particles capable of masking, neutralizing, or absorbing odors, and may include particles that emit a fragrance in proximity to the pouch. The powder within the innermost layer does not dissolve, and the deodorizing properties of the powder may be effective for up to six months. The deodorizing pouch can be used in a method of preventing pets from repeatedly urinating in an interior area by placing the pouch in close proximity to an interior spot where a pet recently urinated.

### CROSS-REFERENCE TO RELATED APPLICATIONS

The present application is a continuation-in-part application of and claims the benefit of priority under 35 U.S.C. § 119(e) of U.S. Nonprovisional application Ser. No. 18/741,967 entitled “No Pee,” filed on Jun. 13, 2024, by Linda Shidler, the entirety of which is hereby incorporated by reference.

### STATEMENT REGARDING FEDERALLY SPONSORED RESEARCH OR DEVELOPMENT (IF APPLICABLE)

N/A

### FIELD OF THE INVENTION

This invention relates generally to pet odor control devices, and more particularly to deodorizing pouches for preventing repeated pet urination in interior areas.

### BACKGROUND OF THE INVENTION

This invention addresses several problems in the prior art of pet odor control devices, specifically deodorizing pouches for preventing repeated pet urination in interior areas.

Pet odor control is a common challenge for many pet owners, particularly those with indoor pets. Urine odors can be persistent and difficult to eliminate, often leading pets to repeatedly urinate in the same spots. This behavior can damage flooring, furniture, and other household items, as well as create an unpleasant living environment for both pets and their owners.

Traditional methods for controlling pet urine odors are limited to sprays, powders that must be applied to a spot and then vacuumed up, and powders incorporated within pee pads. However, these solutions often provide only temporary relief and may not effectively prevent pets from returning to the same areas to urinate. Additionally, some products contain harsh chemicals that can be harmful to pets or irritating to humans. Notably, pee pads, while containing deodorizing powder, actually encourage pets to urinate indoors rather than preventing the behavior.

The current market lacks deodorizing pouches specifically designed for pet odor control. Existing solutions such as sprays require frequent reapplication, while powders that need vacuuming create additional work for pet owners. These products typically do not effectively neutralize the strong ammonia smell associated with pet waste, and their deodorizing effects are often short-lived, requiring frequent replacement or reapplication.

Another challenge with current pet odor control products is their application method. Sprays may not penetrate deeply enough into surfaces, while loose powders can be messy and may be spread throughout the home. The lack of containment for deodorizing agents limits their ability to effectively disperse odor-neutralizing compounds in a controlled manner over time.

The durability of pet odor control products is also a concern. Pets may attempt to interact with these products, potentially ingesting harmful materials. This necessitates the development of solutions that are both pet-safe and resistant to tampering.

Existing solutions have attempted to address these issues through various means. Some spray products use activated charcoal or other absorbent materials to capture odors, while others incorporate fragrances to mask unpleasant smells. Powders may absorb moisture and odors but require direct application and subsequent removal. However, these approaches often fall short in providing long-lasting odor control and preventing pets from re-marking areas.

Thus, there is a need for an innovative approach to pet odor control that overcomes the limitations of sprays, loose powders, and pee pads. A solution that can effectively neutralize pet urine odors, prevent repeated urination in the same areas, and maintain its effectiveness over an extended period without encouraging indoor urination would benefit pet owners by providing a more effective and convenient method for managing pet odors in interior spaces.

### BRIEF SUMMARY OF THE INVENTION

This invention is a deodorizing pouch apparatus and method of preventing pets from repeatedly urinating in interior areas. The deodorizing pouch apparatus neutralizes pet urine odors to discourage pets from marking the same spot again.

The deodorizing pouch apparatus comprises a pouch with one or more layers containing a deodorizing powder with aromatic properties. In a preferred embodiment, the pouch includes an outer layer and an inner layer, both made of breathable material.

The aromatic properties of the powder include the ability to mask, neutralize, or absorb odors in proximity to the pouch. Certain mixtures of powder particles emit a pleasant fragrance. The powder is selected to be effective in neutralizing pet urine odors specifically. In various embodiments, the aromatic properties of the powder work to prevent pets from detecting the scent of previous urination, thereby discouraging them from marking the same spot again. Additionally, the pleasant fragrance emitted by various embodiments of the pouch may help to improve the overall odor of the area.

The preferred embodiment of the pouch features a two-layer construction designed to contain deodorizing powder. The pouch's design, with its two-layer construction, may ensure long-lasting effectiveness when used with appropriate deodorizing powders. The durable construction of the pouch may provide a solution for pet owners dealing with repeated marking behaviors. The pouch is compatible with various commercially available deodorizing powders, allowing users to select a powder that suits their needs.

In various embodiments, the outer layer is typically made of a breathable cotton blend fabric. This layer may provide an attractive appearance and an extra layer of protection for the contents. The outer layer may feature decorative patterns such as dog or cat designs.

In various embodiments, the inner layer is made of fusible interfacing material. This material allows the deodorizing properties of the powder to permeate through the pouch while containing the powder particles. The inner layer may be sealed on all sides to prevent the powder from escaping.

In various embodiments, the deodorizing powder contained within the inner layer has aromatic properties capable of masking, neutralizing, or absorbing odors in proximity to the pouch. The powder may comprise a mix of particles that emits a pleasant fragrance. Importantly, the powder does not dissolve and remains effective for up to six months.

The method disclosed herein comprises placing a deodorizing pouch containing the aromatic powder in close proximity to an interior spot where a pet has recently urinated.

In various embodiments, the method involves placing the pouch on or near the affected area. The pouch's layers are made of breathable materials that allow the deodorizing properties to permeate the surrounding space. The breathable materials may allow the deodorizing properties to permeate the surrounding space, effectively masking or neutralizing pet urine odors.

### BRIEF DESCRIPTION OF THE DRAWINGS

FIG. 1 is a side perspective view of the top side of an embodiment of an outer protective layer.

FIG. 2 is a side perspective view of the bottom side of an embodiment of an outer protective layer.

FIG. 3 is a side elevation view of an embodiment of an outer protective layer.

FIG. 4 is a side perspective view of the top side an embodiment of an outer protective layer.

FIG. 5 is a top plan view of an embodiment of outer protective layer in an unsealed, open configuration.

FIG. 6 is a side perspective view of the top side of an embodiment of an inner layer.

FIG. 7 is a side elevation view of an embodiment of an inner layer.

### DETAILED DESCRIPTION OF THE INVENTION

This invention is a deodorizing pouch apparatus 10 and method of preventing pets from repeatedly urinating in interior areas. The deodorizing pouch apparatus 10 neutralizes pet urine odors to discourage pets from marking the same spot again.

The deodorizing pouch apparatus 10 comprises a pouch with one or more layers containing a deodorizing powder with aromatic properties. In a preferred embodiment, the pouch 10 includes an outer layer 20 and an inner layer 30, both made of breathable material.

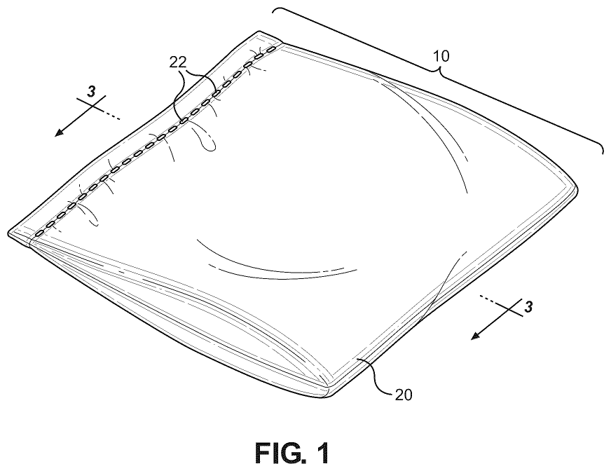

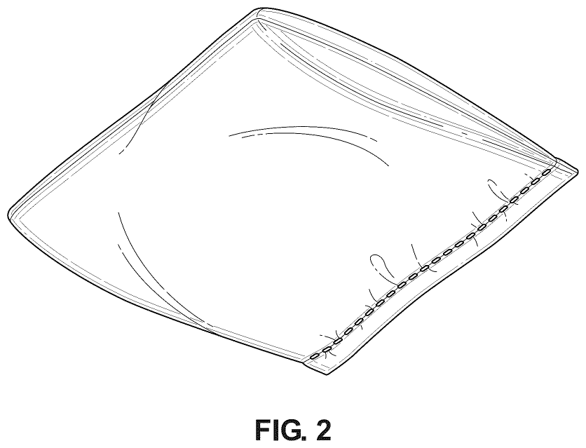

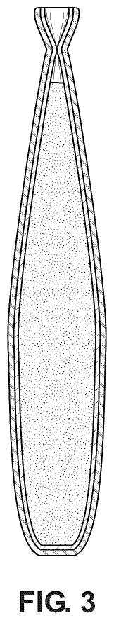

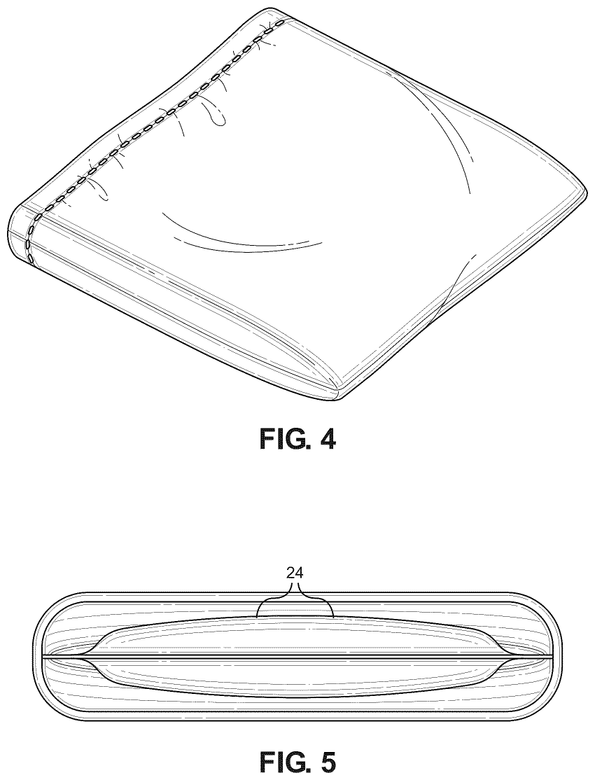

Referring now to FIGS. 1-5 of the drawings, an embodiment of an outer layer 20 is shown. In various embodiments, the outer layer 20 is made of a breathable cotton blend fabric. This layer may provide an attractive appearance and an extra layer of protection for the contents. The outer layer 20 may feature decorative patterns such as dog or cat designs.

In various embodiments, the outer layer 20 is constructed from other breathable natural fibers such as linen, hemp, and/or bamboo fabric. These materials may offer varying degrees of durability and aesthetic appeal while maintaining the necessary breathability for the pouch's 10 functionality. The outer layer 10 may incorporate antimicrobial treatments to further enhance the pouch's odor-fighting capabilities.

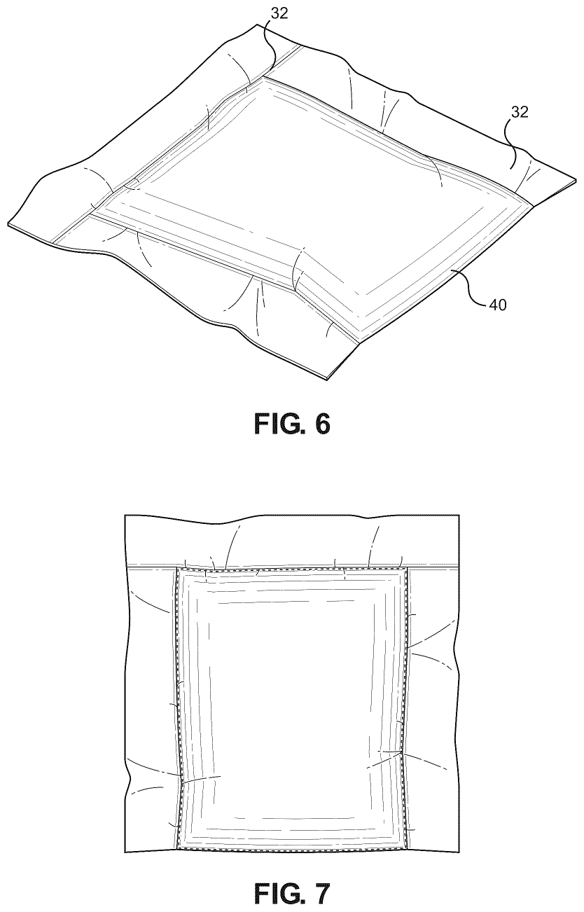

Referring now to FIGS. 6 and 7 of the drawings, an embodiment of an inner layer 30 is shown. In various embodiments, the inner layer 30 is made of fusible interfacing material. This material allows the deodorizing properties of the powder 40 to permeate through the pouch 10 while containing the powder particles 40. The inner layer 30 may be sealed on all sides to prevent the powder 40 from escaping.

In various embodiments, the inner layer 30 is constructed from other materials such as non-woven polyester, fine mesh fabric, and/or microporous membranes. These materials may provide varying levels of breathability while maintaining sufficient particle containment. Some embodiments feature a double-sealed inner layer 30 with reinforced edges for additional durability, and/or specialized heat-sealed seams that create an even more secure containment apparatus while still allowing odor-neutralizing properties to diffuse outward.

The deodorizing powder 40 contained within the inner layer 30 has aromatic properties capable of masking, neutralizing, or absorbing odors in proximity to the pouch 10. In a preferred embodiment, the powder 40 includes a mixture of particles that emit a pleasant fragrance. Importantly, the powder 40 does not dissolve and remains effective for up to six months.

In various embodiments, the pouch's 10 design incorporates materials and construction techniques that optimize its performance with a variety of deodorizing powders 40. The outer layer 20, made of breathable fabric, allows for controlled diffusion of aromatic elements while maintaining an attractive appearance. The inner layer 30, constructed from a fine, porous material, effectively contains powder particles of various sizes while permitting the release of active ingredients. This dual-layer system creates a microenvironment that can enhance the effectiveness of many commercial deodorizing products. The pouch's 10 shape and size are engineered to provide a surface area for dispersal, making it suitable for use with powders 40 of different densities and compositions. Additionally, the durable construction ensures the pouch 10 maintains its integrity over time, even when used with powders 40 that may have moisture-absorbing properties.

To make the preferred embodiment of the invention, a powder mixture 40 is identified and mixed (if applicable) from one or more powders 40. The powder mixture 40 will have the deodorizing properties described herein and may include fragrant properties. The powder mixture 40 is placed in the central area of a sheet of fusible, breathable material, generally having dimensions of around 4 inches by 4 inches. Once the powder mixture 40 is placed, the fusible material is fused or sealed, typically by folding the sheet in half to cover the powder 40, then applying a hot iron to the sides of the sheet where folded material overlaps 32. Once sealed, the inner layer 30 containing the powder mixture 40 is placed within an opening 24 in an outer layer 20, as shown in FIG. 5. Once placed, the outer layer 20 may also be sealed, typically by stitching 22 closed the open portion 24. The sealed pouch 10 may then be placed on or near a location of recent pet urination.

The method disclosed herein comprises placing a deodorizing pouch 10 containing the aromatic powder 40 in close proximity to an interior spot where a pet has recently urinated.

In various embodiments, the method involves placing the pouch 10 on or near the affected area. The pouch's 10 layers are made of breathable materials that allow the deodorizing properties to permeate the surrounding space, effectively masking or neutralizing pet urine odors.

In alternative methods, the pouch 10 is suspended from nearby furniture using an attached loop and/or string, affixed to vertical surfaces with removable adhesive strips, or positioned inside decorative holders that complement home décor. For hard-to-reach areas, the pouch 10 may be attached to the underside of furniture using hook-and-loop fasteners. Some users may find success by placing multiple pouches 10 strategically around problem areas to create an odor barrier zone. For severe cases, pouches 10 are layered and/or stacked to increase the concentration of deodorizing properties. The pouch 10 is also placed inside ventilation areas to distribute the fragrance more widely throughout a room, and/or incorporated into pet bedding areas as a preventative measure.

In various embodiments, the aromatic properties function through various mechanisms. The pouch 10 is designed to accommodate various types of deodorizing powders 40, allowing for flexibility in addressing different odor control needs. The breathable layers of the pouch 10 enable the dispersion of aromatic properties from contained powders 40, which may help in managing pet-related odors. The pouch's 10 construction allows it to function effectively with a range of commercially available deodorizing products, potentially enhancing their effectiveness through controlled release. The versatile design of the pouch 10 makes it suitable for use in various household environments and situations, including multi-pet households or areas with specific odor control challenges.

Although various embodiments have been described with reference to the figures, other embodiments are possible. For example, a person of ordinary skill in the art will understand that the apparatus disclosed herein may comprise one layer or more than two layers without deviating from the scope of this disclosure.

Although an exemplary apparatus has been described with reference to the figures, other implementations may be deployed in other industrial, scientific, medical, commercial, and/or residential applications.

A number of implementations have been described. Nevertheless, it will be understood that various modifications may be made. For example, advantageous results may be achieved if the steps of the disclosed techniques were performed in a different sequence, or if components of the disclosed apparatuses were combined in a different manner, or if the components were supplemented with other components. Accordingly, other implementations are contemplated.

What is claimed is:

1. A deodorizing pouch, comprising:
at least one layer, being made of breathable material; and
a powder contained within the at least one layer, said powder having aromatic deodorizing properties.

2. The deodorizing pouch of claim 1, having two layers, being an outer layer and an inner layer.

3. The deodorizing pouch of claim 1, wherein the outermost layer is made of a breathable cotton blend fabric.

4. The deodorizing pouch of claim 1, wherein the innermost layer is made of fusible interfacing.

5. The pouch of claim 1, wherein said powder further comprises particles capable of masking, neutralizing, or absorbing an odor in proximity to the pouch.

6. The pouch of claim 1, wherein said powder further comprises particles capable of emitting a fragrance in proximity to the pouch.

7. The pouch of claim 1, wherein the powder within the innermost layer does not dissolve.

8. The pouch of claim 1, wherein the deodorizing properties of the powder are effective for up to six months.

9. A deodorizing pouch, comprising:
an outer layer and an inner layer, said layers being made of breathable material; and
a powder contained within the inner layer, said powder having aromatic deodorizing properties, said aromatic properties being effective for up to six months.

10. The outer layer of claim 9, being made of a breathable cotton blend fabric.

11. The inner layer of claim 9, being made of fusible interfacing.

12. The pouch of claim 9, wherein said powder further comprises particles capable of masking, neutralizing, or absorbing an odor in proximity to the pouch.

13. The pouch of claim 9, wherein said powder further comprises particles capable of emitting a fragrance in proximity to the pouch.

14. The pouch of claim 9, wherein the powder within the inner layer does not dissolve.

15. A method of preventing pets from repeatedly urinating in an interior area, comprising:
with a pouch containing a deodorizing powder, placing the pouch in close proximity to an interior spot whereon a pet recently urinated.

16. The method of claim 15, wherein said pouch is made of breathable material.

17. The method of claim 15, wherein the pouch further comprises two layers, including an outer layer and an inner layer.

18. The method of claim 15, wherein the powder has aromatic properties capable of masking, neutralizing, or absorbing odors in proximity to the pouch.

19. The method of claim 15, wherein the pouch also applies a pleasant fragrance to the area in proximity to the pouch.

20. The method of claim 15, wherein pets will not be capable of smelling pet urine in close proximity to the pouch.
